(19) United States
(12) Patent Application Publication
(10) Pub. No.: US 2009/0019708 A1
(43) Pub. Date: Jan. 22, 2009

(54) Instrument for feeding solid nourishment and liquid nourishment independently of each other using only one hand

(76) Inventor: Albert Nazarian, Livingston, NJ (US)

Correspondence Address: CHARLES E. BAXLEY, ESQUIRE, 90 JOHN STREET, SUITE 309, NEW YORK, NY, 10038, US

(21) Appl. No.: 11/879,861

(22) Filed: Jul. 18, 2007

(51) Int. Cl. A47J 43/28

(52) U.S. Cl. 30/322; 30/324

(57) ABSTRACT

An instrument for feeding solid nourishment and liquid nourishment by a care giver independently of each other typically to an infant and/or a physically-challenged individual using only one hand if the care giver. The instrument includes a head and a handle. The head is for taking the solid nourishment for the infant and/or the physically-challenged individual. The handle extends from the head and contains a reservoir for containing the liquid nourishment. The handle has an end opposite to the head for feeding the liquid nourishment. By rotating the handle using the one hand, the solid nourishment and liquid nourishment are taken independently of each other.

### BACKGROUND OF THE INVENTION

A. Field of the Invention

The present invention relate to an instrument for feeding nourishment, and more particularly, it relates to an instrument for use by a care giver to feed solid nourishment and liquid nourishment independently of each other typically to an infant and/or a physically-challenged individual using only one hand of the care giver. The instrument could likewise be used by a person feeding herself or himself or others. It could also be used in original packaging.

B. Description of the Prior Art

Numerous innovations for spoon-related devices have been provided in the prior art that will be described below, which are in chronological order to show advancement in the art, and which are incorporated herein by reference thereto. Even though these innovations may be suitable for the specific individual purposes to which they address, they each differ in structure, and/or operation, and/or purpose from the embodiments of the present invention in that they do not teach an instrument for use by a care giver to feed solid nourishment and liquid nourishment independently of each other to an infant and/or a physically-challenged individual using only one hand of the care giver.
(1) U.S. Pat. No. 3,116,152 to Smith.
U.S. Pat. No. 3,116,152 issued to Smith on Dec. 31, 1963 in class 99 and subclass 171 teaches a throw-away baby food-containing and -feeding unit for single-handed use, including a collapsible tube containing a predetermined quantity of non-solid food and being of a cross-sectional dimension that it may be utilized as a handle. The tube has a forward end provided with a conical, axially located, outwardly projecting, integral discharge nipple. The nipple, when opened, enables the food in the container to be progressively ejected and thus dispensed for use. The apical tip portion of the nipple is easily openable when severed, so that one catching hold of the tube and squeezing it and compressing the container discharges the food in the tube and thus discharges it in a restricted quantity. A spoon has a bowl integrally joined and thus combined with the forward end of the tube. That portion of the construction providing the junctional joint between the spoon and tube is substantially rigid and the nipple overhangs the bowl of the spoon with which it cooperates.
(2) U.S. Pat. No. 3,473,221 to Flanders.
U.S. Pat. No. 3,473,221 issued to Flanders on Oct. 21, 1969 in class 30 and subclass 141 teaches a baby feeding spoon having a bowl portion with a flexible membrane extending across the recess therein and a handle having a bulb portion thereon for forcing air into the bulb portion to elevate the membrane to a position where the food in the spoon can be easily removed therefrom.
(3) U.S. Pat. No. 4,830,222 to Read.
U.S. Pat. No. 4,830,222 issued to Read on May 16, 1989 in class 222 and subclass 106 teaches a disposable combined container and feeding spoon, particularly useful for storing and feeding baby food, including a collapsible envelope of relatively thin, flexible plastic for holding the food. The envelope is bonded to the elongated handle of a spoon, and a narrow severable projection of the envelope extends over the bowl of the spoon. When the projection is severed, food may be squeezed out of the envelope by pressing the envelope against the handle to force controlled quantities of the food onto the bowl of the spoon to permit feeding of persons, such as babies, therefrom.
(4) U.S. Pat. No. 5,682,931 to Mouchmouchian.
U.S. Pat. No. 5,682,931 issued to Mouchmouchian on Nov. 4, 1997 in class 141 and subclass 319 teaches a baby food jar directly attachable to the top of a squeezable baby bottle, so that the baby food jar can be inverted on the squeezable bottle to gravitationally transfer the baby food without spilling. Thereafter, a feeding member includes a nozzle attaching directly to the squeezable baby bottle. The nozzle terminates in a baby feeding spoon. Squeezing the bottle delivers baby food directly to the spoon.
(5) U.S. Pat. No. 5,938,053 to Verbovszky et al.
U.S. Pat. No. 5,938,053 issued to Verbovszky et al. on Aug. 17, 1999 in class 215 and subclass 6 teaches a combination baby bottle and solid food compartment with spoon adapted for use with a small child in the range of 3 months to 4½ years of age. The bottle is shaped for gripping by the child and is divided into multiple compartments for holding separate liquids. The compartments are accessed through a valve arrangement, and the liquids can be dispensed by way of a sipper, straws, or a nipple. The nipple is adapted to simulate a woman's breast, with the texture of the surface area of the nipple extension and surrounding the extension having a raspberry effect. The food compartment fits on the bottom of the bottle in an inverted position to provide a wide base for the combination. The handle of the spoon is shaped to fit the contour of the bottle to which it is secured by a clip. The spoon is shaped to fit the child's mouth or oral cavity.
(6) U.S. Pat. No. 6,928,870 to Liebowitz.
U.S. Pat. No. 6,928,870 issued to Liebowitz on Aug. 16, 2005 in class 73 and subclass 426 teaches a spice storage and dispensing system configured as a spoon, including a handle for the storage of spice and a bowl for the measurement and dispensing of spice received from the handle.
(7) U.S. Pat. No. 7,001,357 to Berry, Sr.
U.S. Pat. No. 7,001,357 issued to Berry, Sr. on Feb. 21, 2006 in class 604 and subclass 77 teaches a device for feeding a young child without the threat of choking. The device includes a handle member in combination with an elongate food-receiving mesh container having an aperture in one end thereof. A ring component too large to swallow is mounted in the aperture. One end of the handle member has a circularly disposed sealing surface, and has a securing member around its adjacent exterior surface. A closure ring having a securing member around its interior surface is able to interfit with the securing member of the handle end. The closure ring has a central aperture of a size to closely receive the container but not permitting the passage of the ring component. When the closure ring has been tightened upon the handle end, the ring component tightly engages the circularly disposed sealing surface on the handle, holding the container in an operative position.
(8) United States Patent Application Publication Number 2006/0219316 to DeJonge.
United States Patent Application Publication Number 2006/0219316 published to DeJonge on Oct. 5, 2006 in class 141 and subclass 112 teaches a combination spoon-lid and a cap for a container, including a main container cap and a spoon-lid. The main container cap has a top and at least one sidewall and has a dispensing orifice located on the top. The cap also has a container-attachment mechanism for removably attaching the cap to a container, and has a spoon-lid attachment mechanism on the top adapted to receive the spoon-lid and close the dispensing orifice. The spoon-lid has a main structure with a first end with a scoop spoon section and has a second end in the form of a handle and has an adjustable gate for increasing and decreasing the volume of the scoop spoon section. The spoon-lid is removably connectable to the attachment mechanism of the main cap to cover and seal the dispensing orifice.
(9) Canadian Patent Number 712,465 to Smith.
(10) United Kingdom Patent Number 2,400,837 to Noble.

It is apparent that numerous innovations for spoon-related devices have been provided in the prior art that are adapted to be used. Furthermore, even though these innovations may be suitable for the specific individual purposes to which they address, they would not be suitable for the purposes of the embodiments of the present invention as heretofore described, typically an instrument for taking solid nourishment and liquid nourishment independently of each other for an infant and/or a physically-challenged individual using only one hand.

### SUMMARY OF THE INVENTION

Thus, an object of the embodiments of the present invention is to provide an instrument for feeding solid nourishment and liquid nourishment typically by a care giver independently of each other for an infant and/or a physically-challenged individual using only one hand of the care giver, which avoids the disadvantages of the prior art.

Briefly stated, another object of the embodiments of the present invention is to provide an instrument for feeding solid nourishment and liquid nourishment by a care giver independently of each other for an infant and/or a physically-challenged individual using only one hand of the care giver. The instrument includes a head and a handle. The head is for taking the solid nourishment for the infant and/or the physically-challenged individual. The handle extends from the head and defines a reservoir for containing the liquid nourishment. The handle has an end opposite to the head for feeding the liquid nourishment to the infant and/or the physically-challenged individual. By rotating the handle using only the one hand of the care giver, the solid nourishment and liquid nourishment are taken independently of each other.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective view of the instrument of an embodiment of the present invention feeding solid nourishment and liquid nourishment by a care giver independently of each other to an infant and/or a physically-challenged individual using only one hand of the care giver wherein the head is shown as a bowl of a spoon and an end of the handle is a nipple;

FIG. 2 is a diagrammatic perspective view of the area generally enclosed by the dotted curve identified by ARROW 2 in FIG. 1 of an alternate embodiment of the head of the instrument wherein the head is a fork; and

FIG. 3 is a diagrammatic perspective view of the area generally enclosed by the dotted curve identified by ARROW 3 in FIG. 1 of an alternate embodiment of the end of the handle of the instrument wherein the end of the handle is a slit.

### LIST OF REFERENCE NUMERALS UTILIZED IN THE DRAWING

A. General.
10 instrument of embodiments of present invention for feeding or taking solid nourishment 12 and liquid nourishment 14 by a care giver independently of each other for infant 16 and/or physically-challenged individual 18 using only one hand 20 of the care giver
12 solid nourishment
14 liquid nourishment
16 infant
18 physically-challenged individual
20 only one hand of the care giver or someone feeding herself or himself

B. Overall Configuration.
22 head for taking solid nourishment 12 for infant 16 and/or physically-challenged individual 18
24 handle
26 reservoir contained in handle 24 for containing liquid nourishment 14
28 end of handle 24 for taking liquid nourishment 14 for infant 16 and/or physically-challenged individual

C. Specific Configuration of Head 22.
30 bowl of spoon 32 of head 22 for taking solid nourishment 12 for infant 16 and/or physically-challenged individual 18
32 spoon of head 22
34 fork of head 22 for taking solid nourishment 12 for infant 16 and/or physically-challenged individual 18 using only one hand 20

D. Specific Configuration of Handle 24.
36 nipple of end 28 of handle 24 for taking liquid nourishment 14 for infant 16 and/or physically-challenged individual 18
38 slit of end 28 of handle 24 for taking liquid nourishment 14 for infant 16 and/or physically-challenged individual 18

### DETAILED DESCRIPTION OF THE PREFERRED EMBODIMENTS

### A. GENERAL

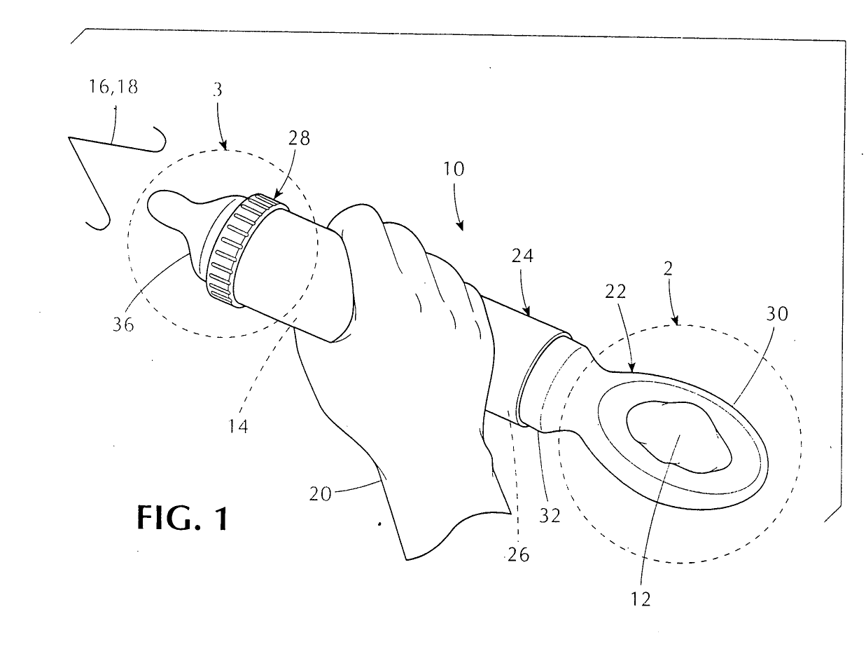

Referring now to the figures, in which like numerals indicate like parts, and particularly to FIG. 1, which is a diagrammatic perspective view of the instrument of an embodiment of the present invention taking solid nourishment and liquid nourishment independently of each other for an infant and/or a physically-challenged individual using only one hand wherein the head is a bowl of a spoon and an end of the handle is a nipple, the instrument of the embodiments of the present invention is shown generally at 10 for taking solid nourishment 12 and liquid nourishment 14 independently of each other for an infant 16 and/or a physically-challenged individual 18 using only one hand 20.

### B. THE OVERALL CONFIGURATION

The instrument 10 includes a head 22 and a handle 24. The head 22 is for taking the solid nourishment 12 for the infant 16 and/or the physically-challenged individual 18. The handle 24 extends from the head 22 and contains a reservoir 26 for containing the liquid nourishment 14. The handle 24 has an end 28 opposite to the head 22 for taking the liquid nourishment 14 for the infant 16 and/or the physically-challenged individual 18. By rotating the handle 24 using the only one hand 20, the solid nourishment 12 and the liquid nourishment 14 are taken independently of each other.

### C. THE SPECIFIC CONFIGURATION OF THE HEAD 22

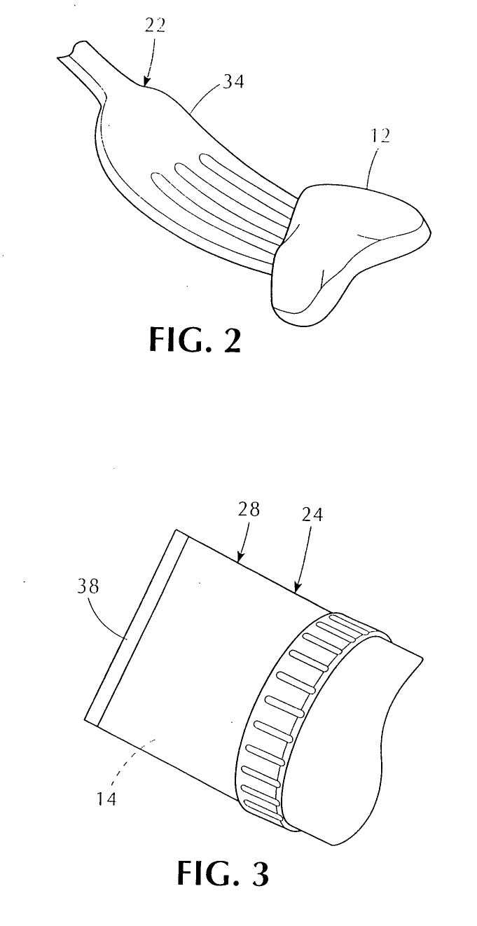

The specific configuration of the head 22 can best be seen in FIGS. 1 and 2, which are, respectively, again a diagrammatic perspective view of the instrument of an embodiment of the present invention taking solid nourishment and liquid nourishment independently of each other for an infant and/or a physically-challenged individual using only one hand wherein the head is a bowl of a spoon and an end of the handle is a nipple, and a diagrammatic perspective view of the area generally enclosed by the dotted curve identified by ARROW 2 in FIG. 1 of an alternate embodiment of the head of the instrument wherein the head is a fork, as shown in FIG. 1, the head 22 is a bowl 30 of a spoon 32 for taking the solid nourishment 12, and as shown in FIG. 2, the head 22 is a fork 34 for taking the solid nourishment 12.

### D. THE SPECIFIC CONFIGURATION OF THE HANDLE 24

The specific configuration of the end 28 of the handle 24 can best be seen in FIGS. 1 and 3, which are, respectively, again a diagrammatic perspective view of the instrument of an embodiment of the present invention taking solid nourishment and liquid nourishment independently of each other for an infant and/or a physically-challenged individual using only one hand, and a diagrammatic perspective view of the area generally enclosed by the dotted curve identified by ARROW 3 in FIG. 1 of an alternate embodiment of the end of the handle of the instrument wherein the end of the handle is a slit.

As shown in FIG. 1, the end 28 of the handle 24 is a nipple 36 for taking the liquid nourishment 14, and as shown in FIG. 3, the end 28 of the handle 24 is a slit 38 for taking the liquid nourishment 14 that is more viscous than would be able to pass through the nipple 36 of the end 28 of the handle 24.

### E. THE CONCLUSIONS

It will be understood that each of the elements described above or two or more together may also find a useful application in other types of constructions differing from the types described above.

While the embodiments of the present invention have been illustrated and described as embodied in an instrument for taking solid nourishment and liquid nourishment independently of each other for an infant and/or a physically-challenged individual using only one hand, however, they are not limited to the details shown, since it will be understood that various omissions, modifications, substitutions, and changes in the forms and details of the embodiments of the present invention illustrated and their operation can be made by those skilled in the art without departing from the spirit of the embodiments of the present invention.

Obviously the instrument could likewise be used by a person feeding herself or himself. Further the instrument could be used also in original packaging along with a cup of non-liquid food. Thereby a user could hold the cup in one hand and merely reverse the spoon to drink liquid.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. An instrument for taking solid nourishment and liquid nourishment independently of each other using only one hand, comprising:
a) a head; and
b) a handle;
wherein said head is for taking the solid nourishment;
wherein said handle extends from said head;
wherein said handle defines a reservoir;
wherein said reservoir is for containing the liquid nourishment;
wherein said handle has an end;
wherein said end of said handle is opposite to said head; and
wherein said end of said handle is for taking the liquid nourishment and by rotating said handle using the only one hand, the solid nourishment and the liquid nourishment are taken independently of each other.

2. The instrument of claim 1, wherein said head is a bowl of a spoon for taking the solid nourishment.

3. The instrument of claim 1, wherein said head is a fork for taking the solid nourishment.

4. The instrument of claim 1, wherein said end of said handle is an openable and reclosable opening a for taking the liquid nourishment.

5. The instrument of claim 4, wherein said openable and reclosable opening is a nipple.

6. The instrument of claim 1, wherein said end of said handle is an openable and reclosable slit for taking the liquid nourishment which is more viscous than would be able to pass through said end of said handle if said end of said handle were a nipple.
